(19) United States
(12) Patent Application Publication
(10) Pub. No.: US 2024/0276330 A1
(43) Pub. Date: Aug. 15, 2024

(54) CELL RESELECTION METHOD AND USER EQUIPMENT

(71) Applicant: KYOCERA Corporation, Kyoto (JP)

(72) Inventors: Masato FUJISHIRO, Yokohama-shi (JP); Mitsutaka HATA, Yokohama-shi (JP); Henry CHANG, San Diego, CA (US)

(73) Assignee: KYOCERA Corporation, Kyoto (JP)

(21) Appl. No.: 18/638,879

(22) Filed: Apr. 18, 2024

Related U.S. Application Data
(63) Continuation of application No. PCT/JP2022/038731, filed on Oct. 18, 2022.
(60) Provisional application No. 63/257,659, filed on Oct. 20, 2021.

(51) Int. Cl. H04W 36/08; H04W 36/00; H04W 36/30

(52) U.S. Cl. CPC H04W 36/08; H04W 36/0061; H04W 36/00835; H04W 36/30

(57) ABSTRACT

In a first aspect, a cell reselection method is performed by a user equipment in a mobile communication system. The cell reselection method includes: receiving, from a network, slice frequency information indicating a plurality of frequencies and a network slice group supported by each of the plurality of frequencies; and when a predetermined frequency not supporting a predetermined network slice group, of which an AS layer is notified by a NAS layer of a user equipment, is present in the slice frequency information, performing control in which a cell belonging to the predetermined frequency is less likely to be selected as a serving cell than a cell belonging to a frequency supporting the predetermined network slice group.

### RELATED APPLICATIONS

The present application is a continuation based on PCT Application No. PCT/JP2022/038731, filed on Oct. 18, 2022, which claims the benefit of U.S. Provisional Patent Application No. 63/257,659 filed on Oct. 20, 2021. The content of which is incorporated by reference herein in their entirety.

### TECHNICAL FIELD

The present disclosure relates to a cell reselection method and a user equipment used in a mobile communication system.

### BACKGROUND OF INVENTION

In specifications of the Third Generation Partnership Project (3GPP), which is a standardization project for mobile communication systems, Network Slicing has been defined (for example, see Non-Patent Document 1). Network slicing is a technique for configuring a network slice that is a virtual network by logically dividing a physical network constructed by a telecommunications carrier.

### CITATION LIST

### Non-Patent Literature

Non-Patent Document 1: 3GPP TS 38.300 V16.6.0 (2021-06)

### SUMMARY

In a first aspect, a cell reselection method is performed by a user equipment in a mobile communication system. The cell reselection method includes: receiving, from a network, slice frequency information indicating a plurality of frequencies and a network slice group supported by each of the plurality of frequencies; and when a predetermined frequency not supporting a predetermined network slice group, of which an AS layer is notified by a NAS layer of a user equipment, is present in the slice frequency information, performing control in which a cell belonging to the predetermined frequency is less likely to be selected as a serving cell than a cell belonging to a frequency supporting the predetermined network slice group.

In a second aspect, a user equipment is used in a mobile communication system. The user equipment includes a processor. The processor is configured to perform: processing of receiving, from a network, slice frequency information indicating a plurality of frequencies and a network slice group supported by each of the plurality of frequencies, and when a predetermined frequency not supporting a predetermined network slice group, of which an AS layer is notified by a NAS layer of a user equipment, is present in the slice frequency information, processing of performing control in which a cell belonging to the predetermined frequency is less likely to be selected as a serving cell than a cell belonging to a frequency supporting the predetermined network slice group.

In a third aspect, a cell reselection method is performed by a user equipment in a mobile communication system. The cell reselection method includes: receiving, from a network, slice frequency information indicating a correspondence relationship between network slices, frequencies, and frequency priorities; assigning the frequency priorities indicated by the slice frequency information to corresponding frequencies for a selected network slice selected by a user equipment; and reselecting a candidate cell satisfying a predetermined quality standard within a selected frequency selected by the user equipment in accordance with the assigned frequency priorities. The reselecting includes reselecting, when a first candidate cell having a highest radio quality does not provide the selected network slice, a second candidate cell that is different from the first candidate cell and provides the selected network slice.

In a fourth aspect, a cell reselection method is performed by a user equipment in a mobile communication system. The cell reselection method includes: receiving, from a network, slice frequency information indicating a correspondence relationship between network slices, frequencies, and frequency priorities; assigning the frequency priorities indicated by the slice frequency information to corresponding frequencies for a selected network slice selected by a user equipment; determining whether a candidate cell provides the selected network slice, the candidate cell satisfying a predetermined quality standard within a selected frequency selected by the user equipment in accordance with the assigned frequency priorities; and performing cell reselection processing using only the selected frequency or the candidate cell as a reselection candidate when no cell provides the selected network slice in the selected frequency.

In a fifth aspect, a cell reselection method is performed by a user equipment in a mobile communication system. The cell reselection method includes: receiving, from a serving cell, a message indicating whether the serving cell provides neighboring cell information indicating a correspondence relationship between a neighboring cell and a network slice provided by the neighboring cell; determining, based on the message, whether the serving cell provides the neighboring cell information; and receiving the neighboring cell information from the serving cell in response to determining that the serving cell provides the neighboring cell information.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram for illustrating an overview of a cell reselection procedure.

FIG. 7 is a flowchart illustrating a schematic flow of a typical cell reselection procedure.

FIG. 8 is a diagram illustrating an example of network slicing.

FIG. 9 is a diagram illustrating an overview of a slice-specific cell reselection procedure.

FIG. 10 is a view illustrating an example of slice frequency information.

FIG. 11 is a flowchart illustrating a basic flow of the slice-specific cell reselection procedure.

FIG. 12 is a flowchart illustrating a flow of a slice-specific cell reselection procedure according to a first embodiment.

FIG. 13 is a flowchart illustrating a flow of a slice-specific cell reselection procedure according to a second embodiment.

FIG. 14 is a diagram for illustrating control information according to a third embodiment.

FIG. 15 is a flowchart illustrating a flow of a slice-specific cell reselection procedure according to the third embodiment.

FIG. 16 is a diagram for illustrating a configuration information according to a first Variation of the third embodiment.

FIG. 17 is a view for illustrating operations in the first Variation of the third embodiment.

FIG. 18 is a flowchart illustrating a flow of a slice-specific cell reselection procedure according to a second Variation of the third embodiment.

FIG. 19 is a view for illustrating operations in the second Variation of the third embodiment.

FIG. 20 is a flowchart illustrating a flow of a slice-specific cell reselection procedure according to a fourth embodiment.

FIG. 21 is a diagram illustrating operations according to a fifth embodiment.

### DESCRIPTION OF EMBODIMENTS

A user equipment in a radio resource control (RRC) idle state or an RRC inactive state performs a cell reselection procedure. In the 3GPP, slice-specific cell reselection that is a network slice-dependent cell reselection procedure is under study.

In such slice-specific cell reselection, for example, it is assumed that the user equipment preferentially reselects (that is, camps on) a cell belonging to a frequency having a high frequency priority associated with a network slice that the user equipment wants to use (intended slice). However, a specific method of the slice-specific cell reselection is not yet determined.

The present disclosure relates to a cell reselection method and a user equipment for facilitating slice-specific cell reselection.

A mobile communication system according to an embodiment is described with reference to the drawings. In the description of the drawings, the same or similar parts are denoted by the same or similar reference signs.

### First Embodiment

### Configuration of Mobile Communication System

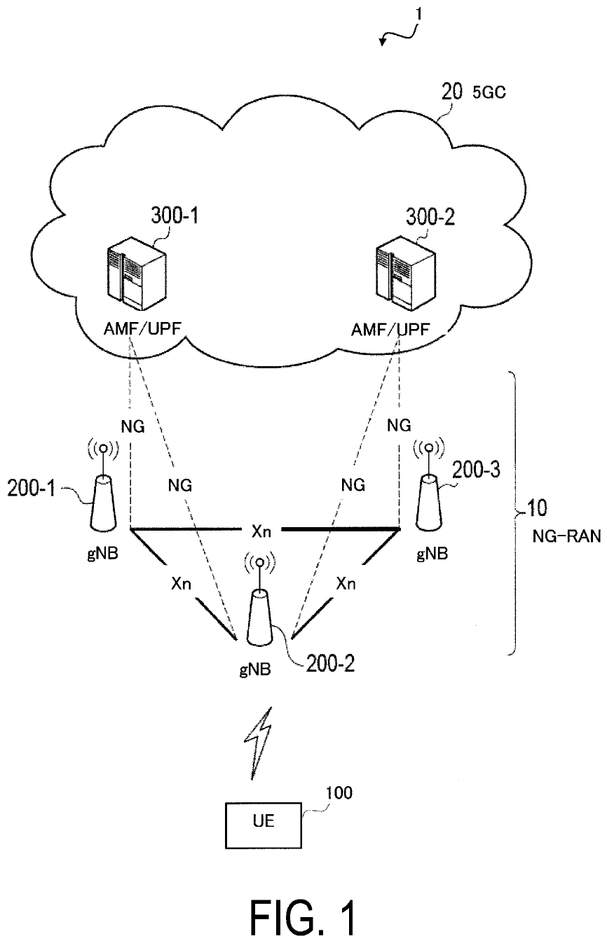

FIG. 1 is a diagram illustrating the configuration of the mobile communication system according to the first embodiment. The mobile communication system 1 complies with the 5th Generation System (5GS) of the 3GPP standard. The description below takes the 5GS as an example, but a Long Term Evolution (LTE) system or a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication to the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (also simply referred to as a “frequency” below).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

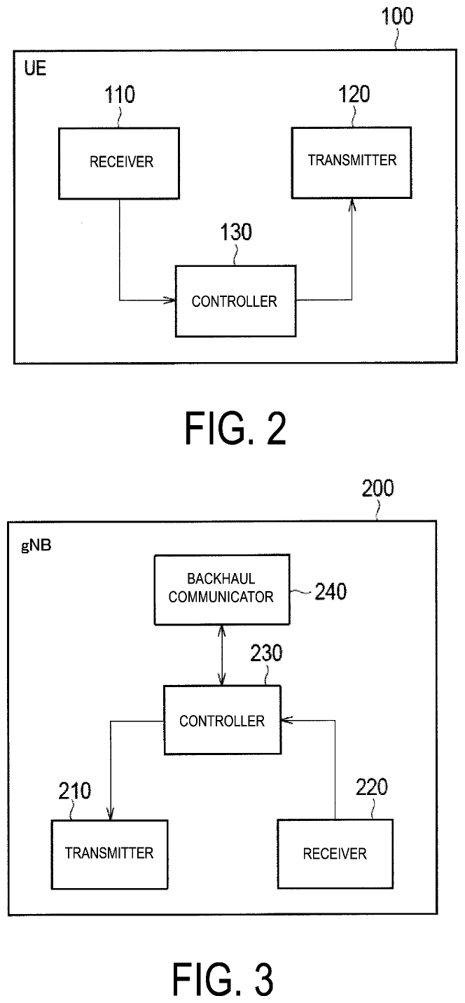

FIG. 2 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processing includes processing of each layer described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processing includes processing of each layer described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the Xn interface, which is an inter-base station interface. The backhaul communicator 240 is connected to the AMF/UPF 300 via the NG interface, which is an interface between the base station and the core network. Note that the gNB 200 may include a Central Unit (CU) and a Distributed Unit (DU) (i.e., functions are divided), and the two units may be connected via an F1 interface, which is a fronthaul interface.

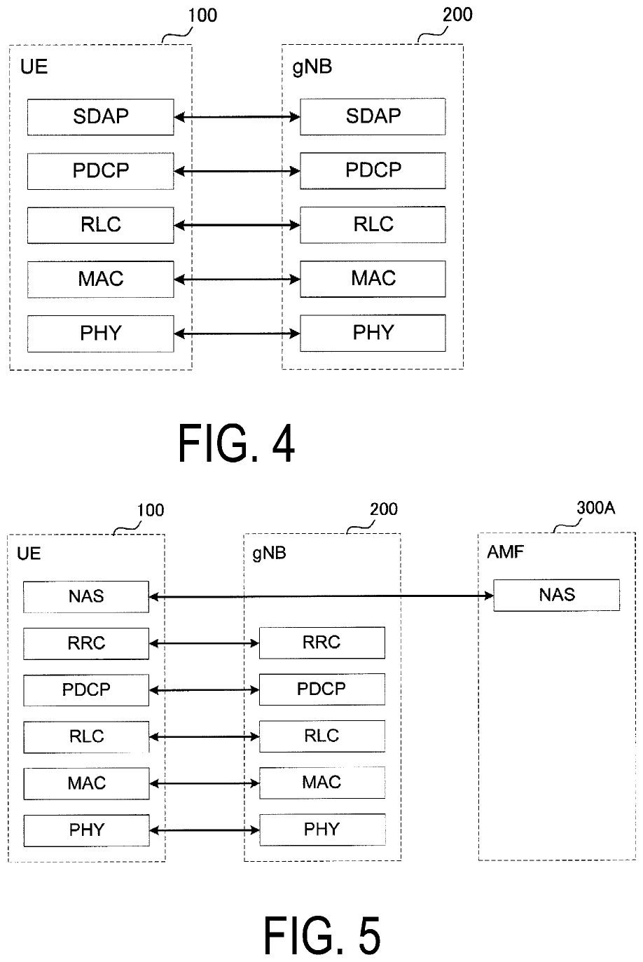

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. The PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled using the RNTI.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines uplink and downlink transport formats (transport block sizes, modulation and coding schemes (MCSs)), and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of QoS control by a core network and a radio bearer as the unit of QoS control by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300A. Note that the UE 100 includes an application layer other than the protocol of the radio interface. A layer lower than the NAS is referred to as Access Stratum (AS).

### Overview of Cell Reselection Procedure

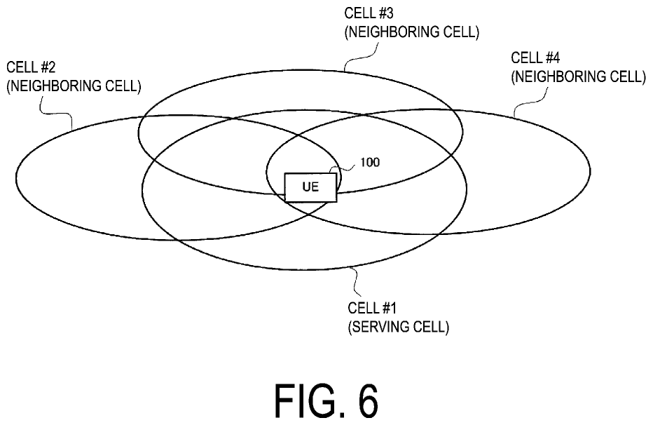

FIG. 6 is a diagram for illustrating an overview of the cell reselection procedure.

The UE 100 in the RRC idle state or the RRC inactive state while moving performs the cell reselection procedure to move from a current serving cell (a cell #1) to a neighboring cell (any one of cells #2 to #4). To be more specific, the UE 100 specifies a neighboring cell on which the UE 100 should camp through the cell reselection procedure and reselects the specified neighboring cell. When the frequency (carrier frequency) is the same between the current serving cell and the neighboring cell is referred to as an intra-frequency, and when the frequency (carrier frequency) is different between the current serving cell and the neighboring cell is referred to as an inter-frequency. The current serving cell and the neighboring cell may be managed by the same gNB 200 or may be managed by the gNBs 200 different from each other.

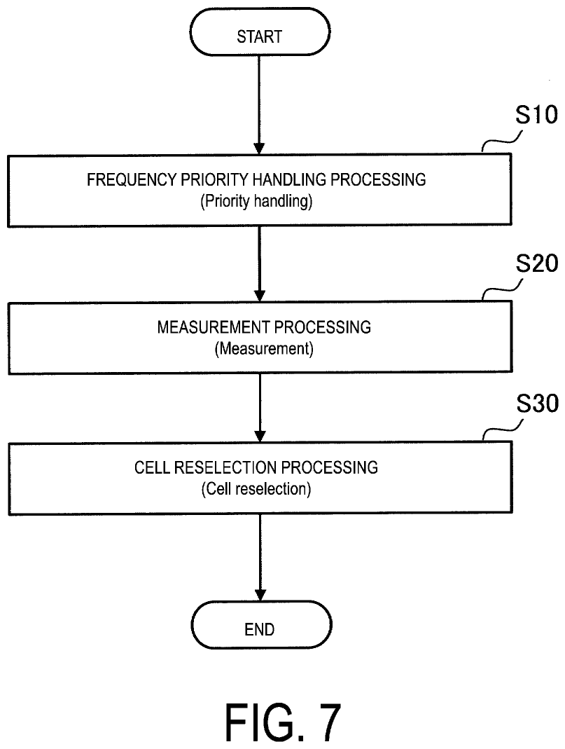

FIG. 7 is a flowchart illustrating a schematic flow of a typical cell reselection procedure.

In step S10, the UE 100 performs frequency priority handling processing based on frequency-specific priorities (also referred to as “absolute priorities”) specified by the gNB 200, for example, by way of a system information block or an RRC release message. To be more specific, the UE 100 manages the frequency priority designated by the gNB 200 for each frequency.

In step S20, the UE 100 performs measurement processing of measuring radio qualities of the serving cell and each of the neighboring cells. The UE 100 measures reception powers and reception qualities of reference signals transmitted by the serving cell and each of the neighboring cells, to be more specific, cell defining-synchronization signal and PBCH block (CD-SSB). For example, the UE 100 measures always the radio quality for a frequency with a priority higher than the priority of the frequency of the current serving cell, and when the radio quality of the current serving cell is lower than a predetermined quality, the UE 100 measures the radio quality for a frequency with a priority equal to or lower than the priority of the frequency of the current serving cell.

In step S30, the UE 100 performs the cell reselection processing of reselecting a cell on which the UE 100 camps based on the measurement result in step S20. For example, the UE 100 may perform cell reselection to a neighboring cell when a priority of a frequency of the neighboring cell is higher than the priority of the current serving cell and when the neighboring cell satisfies a predetermined quality standard (i.e., a minimal quality standard) for a predetermined period of time. When the priories of the frequencies of the neighboring cells are the same as the priority of the current serving cell, the UE 100 may rank the radio qualities of the neighboring cells to perform cell reselection to the neighboring cell ranked higher than a rank of the current serving cell for a predetermined period of time. When the priority of the frequency of the neighboring cell is lower than the priority of the current serving cell, and when the radio quality of the current serving cell is lower than a certain threshold value and the radio quality of the neighboring cell is continuously higher than another threshold value for a predetermined period of time, the UE 100 may perform cell reselection to the neighboring cell.

### Overview of Network Slicing

The network slicing is a technique for virtually dividing a physical network (for example, a network including the NG-RAN 10 and the 5GC 20) constructed by an operator to create a plurality of virtual networks. Each virtual network is referred to as a network slice. Hereinafter, the “network slice” may be simply referred to as a “slice”.

The network slicing allows a communication carrier to create slices according to service requirements of different service types, such as enhanced Mobile Broadband (eMBB), Ultra-Reliable and Low Latency Communications (URLLC), and massive Machine Type Communications (mMTC), for example, to optimize network resources.

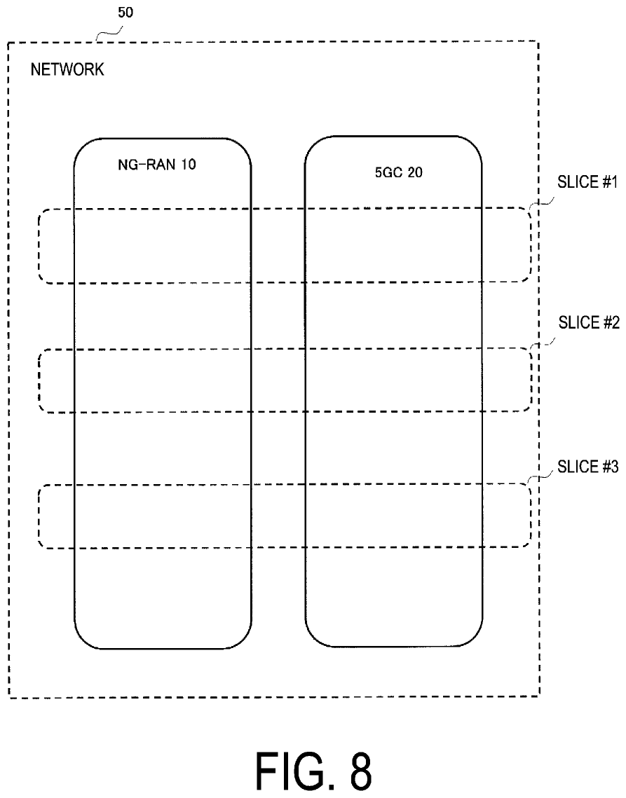

FIG. 8 is a diagram illustrating an example of the network slicing.

Three slices (slices #1 to #3) are configured on a network 50 including the NG-RAN 10 and the 5GC 20. The slice #1 is associated with a service type of eMBB, the slice #2 is associated with a service type of URLLC, and the slice #3 is associated with a service type of mMTC. Note that three or more slices may be configured on the network 50. One service type may be associated with a plurality slices.

Each slice is provided with a slice identifier for identifying the slice. Examples of the slice identifier include a Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a slice is associated. The SD is information for differentiating a plurality of slices associated with the same service type. The information including a plurality of pieces of S-NSSAI is referred to as a Network Slice Selection Assistance Information (NSSAI).

One or more slices may be grouped to configure a slice group. The slice group is a group including one or more slices, and a slice group identifier is assigned to the slice group. The slice group may be configured by the core network (for example, the AMF 300), or may be configured by the radio access network (for example, the gNB 200). The UE 100 may be notified of the configured slice group.

Hereinafter, the term “network slice (or slice)” may refer to an S-NSSAI that is an identifier of a single slice or an NSSA that is a collection of S-NSSAIs, or may refer to one or more S-NSSAIs or a slice group that is a group of NSSAIs.

The UE 100 also determines a desired network slice that the UE 100 wants to use. Such a desired slice may be referred to as an intended slice. In the first embodiment, the UE 100 determines a slice priority for each network slice (desired network slice). For example, the NAS of the UE 100 determines the slice priority based on an operation status of an application in the UE 100 and/or a user operation/setting, and notifies the AS of the decided slice priority.

### Overview of Slice-Specific Cell Reselection Procedure

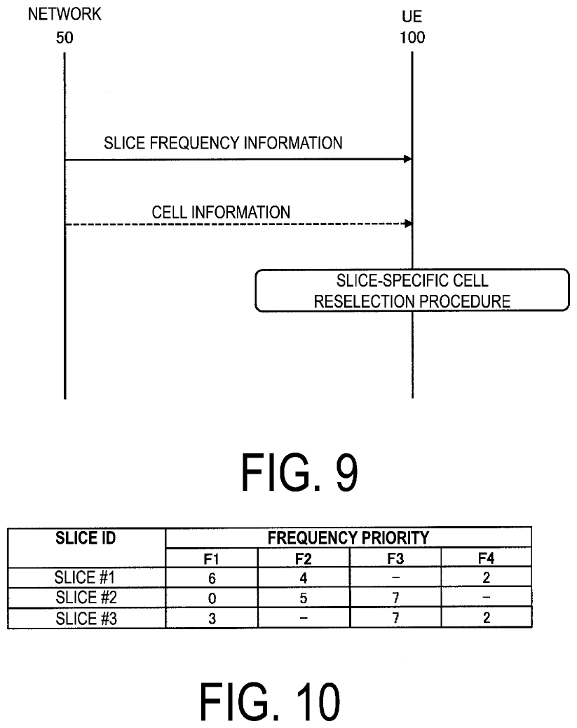

FIG. 9 is a diagram illustrating an overview of the slice-specific cell reselection procedure.

In the slice-specific cell reselection procedure, the UE 100 performs cell reselection processing based on slice frequency information provided from the network 50. The slice frequency information may be provided from the gNB 200 to the UE 100 through broadcast signaling (for example, a system information block) or dedicated signaling (for example, an RRC release message).

The slice frequency information is information indicating a correspondence relationship between network slices, frequencies, and frequency priorities. For example, the slice frequency information indicates, for each slice (or slice group), a frequency (one or more frequencies) that supports the slice and a frequency priority assigned to each frequency. An example of the slice frequency information is illustrated in FIG. 10.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example of FIG. 10, the larger the number of the frequency priority, the higher the priority is, but a case in which the smaller the number, the higher the priority is may also be possible.

Three frequencies F1, F2, and F3 are associated with the slice #2 as frequencies that support the slice #2. Among these three frequencies, the frequency priority of F1 is “0”, the frequency priority of F2 is “5”, and the frequency priority of F3 is “7”.

Three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice-specific frequency priority” in order to be distinguished from the absolute priority in the conventional cell reselection procedure.

The UE 100 may perform the cell reselection processing further based on cell information provided from the network 50. The cell information may be information indicating a correspondence relationship between a cell (for example, a serving cell and each neighboring cell) and a network slice that is not provided or provided by the cell. For example, a cell may temporarily fail to provide some or all network slices due to congestion or the like. That is, even for a slice support frequency capable of providing a network slice, some cells within the frequency may not provide the network slice. Based on the cell information, the UE 100 may grasp which network slice is not provided by each cell. The cell information like this may be provided from the gNB 200 to the UE 100 through broadcast signaling (for example, a system information block) or dedicated signaling (for example, an RRC release message).

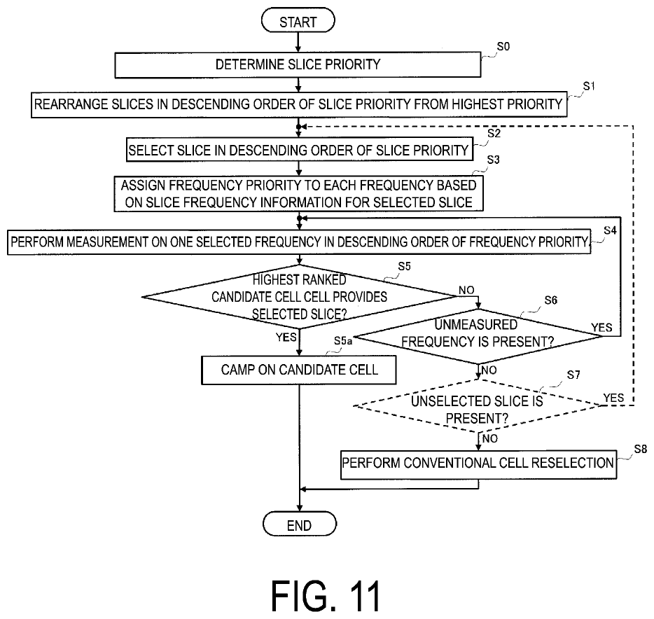

FIG. 11 is a flowchart illustrating a basic flow of the slice-specific cell reselection procedure. Before starting the slice-specific cell reselection procedure, the UE 100 is assumed to be in the RRC idle state or the RRC inactive state, and to receive and retain the above-mentioned slice frequency information.

In step S0, the NAS of UE 100 determines the slice identifiers of the desired slices for the UE 100 and the slice priorities of the desired slices, and notifies the AS of the UE 100 of slice information including the determined slice priorities. The “desired slice” includes a slice that is likely to be used, a candidate slice, a wanted slice, a slice with which communication is desired, a requested slice, an allowed slice, or an intended slice. For example, the slice priority of the slice #1 is determined to be “3”, the slice priority of the slice #2 is determined to be “2”, and the slice priority of the slice #3 is determined to be “1”. The larger the number of the slice priority, the higher the priority is, but a case in which the smaller the number, the higher the priority is may also be possible.

In step S1, the AS of the UE 100 rearranges the slices (slice identifiers), of which the AS is notified by the NAS in step S0, in descending order of slice priority. A list of the slices arranged in this manner is referred to as a “slice list”.

In step S2, the AS of the UE 100 selects one network slice in descending order of slice priority. The network slice selected in this manner is referred to as a “selected network slice”.

In step S3, the AS of the UE 100 assigns, for the selected network slice, a frequency priority to each of the frequencies associated with that network slice. To be more specific, the AS of the UE 100 specifies frequencies associated with the slice based on the slice frequency information and assigns frequency priorities to the specified frequencies. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 according to the slice frequency information (for example, the information in FIG. 10). The AS of the UE 100 refers to a list of frequencies arranged in descending order of frequency priority as a “frequency list”.

In step S4, the AS of the UE 100 selects one of the frequencies in descending order of frequency priority for the selected network slice selected in step S2, and performs the measurement processing on the selected frequency. The frequency selected in this manner is referred to as a “selected frequency”. The AS of the UE 100 may rank the cells measured within the selected frequency in descending order of radio quality. Among the cells measured within the selected frequency, those cells that satisfy a predetermined quality standard (i.e., a minimal quality standard) are referred to as “candidate cells”.

In step S5, the AS of the UE 100 specifies a cell ranked the highest based on the result of the measurement processing in step S4, and determines whether the cell provides the selected network slice based on the cell information. When determining that the highest ranked cell provides the selected network slice (step S5: YES), the AS of the UE 100 reselects the highest ranked cell and camps on that cell in step S5a.

On the other hand, when determining that the highest ranked cell does not provide the selected network slice (step S5: NO), the AS of UE 100 determines in step S6 whether a frequency not measured is present in the frequency list created in step S3. When determining that a frequency not measured is present (step S6: YES), the AS of the UE 100 resumes the processing for the frequency having the next highest frequency priority, and performs the measurement processing by use of that frequency as selected frequency (returns the processing to step S4).

When determining that a frequency not measured is not present in the frequency list created in step S3 (step S6: NO), the AS of the UE 100 may determine in step S7 whether an unselected slice is present in the slice list created in step S1. When determined that an unselected slice is present (step S7: YES), the AS of the UE 100 resumes the processing for the network slice having the next highest slice priority, and selects that network slice as the selected network slice (returns the processing to step S2). Note that in the basic flow illustrated in FIG. 11, the process in step S7 may be omitted.

When determining that an unselected slice is not present (step S7: NO), the AS of the UE 100 performs conventional cell reselection processing in step S8. The conventional cell reselection processing may mean an entirety of a general cell reselection procedure illustrated in FIG. 7, or may mean only cell reselection processing (step S30) illustrated in FIG. 7. In the latter case, the UE 100 may use the measurement result in step S4 without measuring the radio qualities of the cells again.

### Slice-Specific Cell Reselection Procedure According to First Embodiment

In the basic flow of the slice-specific cell reselection procedure described above, the AS of the UE 100 selects the slice in step S2 and assigns the frequency priority to each of the frequencies supporting that slice in step S3.

Here, the frequency not supporting that slice is considered to be not provided with a configuration value of the frequency priority (slice-specific frequency priority) in the slice frequency information. Such a frequency is in a state of having no frequency priority, and thus, is considered to be a frequency not included in candidates in the reselection in the slice-specific cell reselection procedure. Therefore, in the slice-specific cell reselection procedure according to the first embodiment, a frequency for which no slice-specific frequency priority is configured is excluded from the reselection candidates.

In the first embodiment, the UE 100 receives, from the network 50, the slice frequency information indicating the correspondence relationship between the network slices, the frequencies, and the frequency priorities. When the frequency not having the frequency priority is present in the slice frequency information for the selected network slice, the UE 100 excludes the frequency not having the priority from candidate frequencies for cell reselection. The UE 100 then reselects a candidate cell satisfying a predetermined quality standard within the selected frequency selected from among the candidate frequencies in accordance with the frequency priorities. This can facilitate the slice-specific cell reselection procedure.

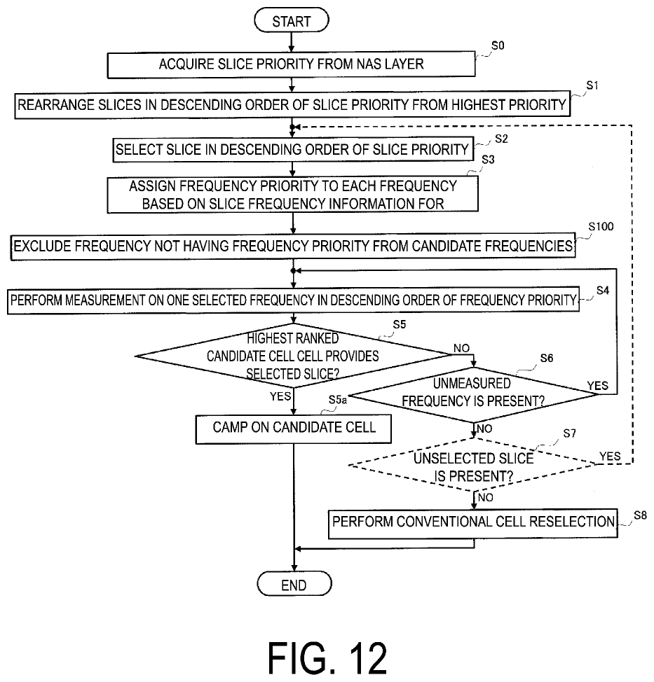

FIG. 12 is a flowchart illustrating a flow of the slice-specific cell reselection procedure according to the first embodiment. Here, differences from FIG. 11 are described.

In step S100, for the selected network slice selected in step S2, the UE 100 excludes the frequency for which no frequency priority is configured from the candidates in the slice-specific cell reselection (to be specific, measurement targets).

### Second Embodiment

A second embodiment is described focusing on differences from the first embodiment concerning the slice-specific cell reselection procedure.

Before the UE 100 performs the slice-specific cell reselection procedure, for example, before the NAS notifies the AS of the intended slice, the UE 100 is considered to be performing the general cell reselection procedure (see FIG. 7). The intended slice may also be considered to be changed during performing the slice-specific cell reselection procedure. Furthermore, the selected slice may be considered to change over from the slice having the highest slice priority to the slice having the second highest slice priority during performing the slice-specific cell reselection procedure (see step S2 and step S7 described above).

In these situations, since the priorities of the respective frequencies change, the AS of the UE 100 needs to exchange (update) the priorities. Here, handling of the frequency priorities that are already applied is a problem. In particular, when the already applied frequency priority (absolute priority or slice-specific frequency priority) is present and no frequency priority (slice-specific frequency priority) is configured for a new intended slice, how to perform the processing needs to be clear.

In the second embodiment, the UE 100 receives, from the network 50, the slice frequency information indicating the correspondence relationship between the network slices, the frequencies, and the frequency priorities. The UE 100 removes the frequency priorities which are already configured for the respective frequencies for the selected network slice selected by the UE 100, and then assigns the frequency priorities indicated by the slice frequency information to the corresponding frequencies. That is, the UE 100 clears the already applied frequency priorities before applying the slice-specific frequency priorities for the selected network slice. The UE 100 then reselects a candidate cell satisfying a predetermined quality standard within a selected frequency selected in accordance with the assigned frequency priorities.

In this way, in the second embodiment, the UE 100 clears the already applied frequency priorities to initialize to a state in which no frequency priority is applied to any frequency, and then performs slice-specific cell reselection.

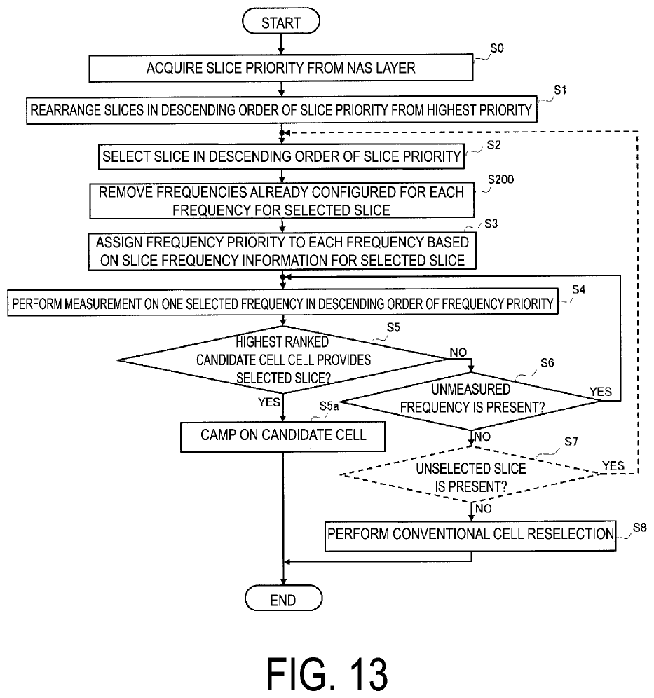

FIG. 13 is a flowchart illustrating a flow of the slice-specific cell reselection procedure according to the second embodiment. Here, differences from FIG. 11 are described.

In step S200, the UE 100 clears all frequency priorities that are already applied for the selected network slice, before step S3. For example, when the frequency priorities are already applied for the selected network slice, the UE 100 removes the already applied frequency priorities for the selected network slice.

Note that the frequency priorities cleared in step S200 may include the frequency priority provided through the broadcast signaling (for example, the SIB). Alternatively, when a frequency priority is configured through dedicated signaling (for example, an RRC Release message), the frequency priority may be prioritized (that is, may be continued to be applied) within a predetermined amount of time after the UE 100 transitions to the RRC inactive state or the RRC idle state (for example, a period during which a timer T320 in the 3GPP standard is operating), and the processing of step S200 may be applied after T320 expires.

### Third Embodiment

A third embodiment is described focusing on differences from the first and second embodiments concerning the slice-specific cell reselection procedure.

As described above, when the highest ranked cell does not provide the selected network slice in step S5, the UE 100 does not reselect that cell. For example, the gNB 200 is considered to be possibly not able to temporarily support a specific slice due to its own resource usage status or the like.

In the example illustrated in FIG. 10, assuming that the slice #1 is the selected network slice, the UE 100 performs measurement on the frequency F1 in step S4, but when the highest ranked cell in the frequency F1 does not (temporarily) provide the selected network slice, it may be preferable for the UE 100 to reselect another candidate cell in the same frequency F1 (i.e., the second or subsequent highest ranked cell).

However, when the UE 100 reselects the second or subsequent highest ranked cell, an interference may affect the highest ranked cell, for example.

In the general cell reselection procedure, i.e. a network slice-independent cell reselection procedure, the network 50 (gNB 200) specifies to the UE 100 whether the UE 100 may reselect another cell in the same frequency when an access to the highest ranked cell is restricted. To be more specific, the gNB 200 notifies the UE 100 of whether to reselect another cell in the same frequency by way of an IFRI (Intra Frequency Reselection Indicator) in a master information block (MIB).

On the other hand, control different from the general cell reselection procedure may be considered to be preferably applied to the slice-specific cell reselection. For example, the interference due to reselection of another cell in the same frequency may be less because of less UE 100 supporting the network slice is less, or the like.

Therefore, the third embodiment introduces a mechanism capable of reselecting a cell other than the highest ranked cell within the same frequency in the slice-specific cell reselection procedure.

In the third embodiment, the UE 100 that receives, from the network 50, the slice frequency information indicating the correspondence relationship between the network slice, the frequencies, and the frequency priorities assigns the frequency priorities indicated by the slice frequency information to the corresponding frequencies for the selected network slice, and reselects a candidate cell satisfying a predetermined quality standard within the selected frequency selected in accordance with the assigned frequency priorities. Here, when a first candidate cell having the highest radio quality (i.e., the highest ranked cell) does not provide the selected network slice, the UE 100 reselects a second candidate cell (i.e., the second or subsequent highest ranked cell) that is different from the first candidate cell and provides the selected network slice.

To be specific, the UE 100 reselects the second candidate cell within a frequency the same as the frequency to which the first candidate cell belongs. The UE 100 may receive control information for controlling whether the second candidate cell is allowed to be reselected within the same frequency from the network 50 (for example, the gNB 200). The control information may be information dedicated to a slice-specific cell reselection procedure which is a network slice-dependent cell reselection procedure. This allows the network 50 to specify whether to allow reselection of a cell other than the highest ranked cell within the same frequency in the slice-specific cell reselection procedure.

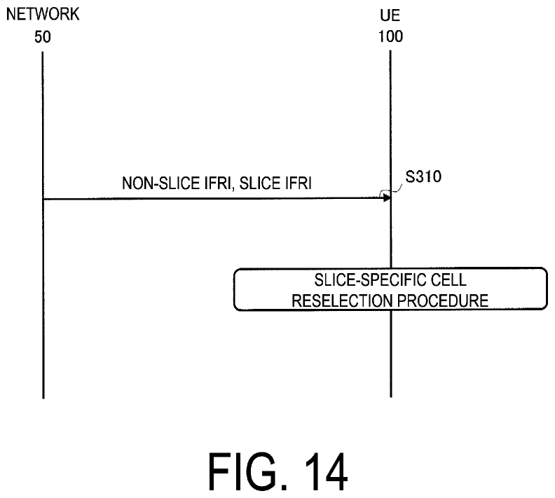

FIG. 14 is a diagram for illustrating the control information according to the third embodiment.

In step S310, the network 50 (gNB 200) transmits to the UE 100 the IFRI (hereinafter referred to as the “slice IFRI”) that is the control information applied only to the slice-specific cell reselection procedure. The network 50 (gNB 200) may notify the UE 100 of the slice IFRI through broadcast signaling (for example, an SIB) or dedicated signaling (for example, an RRC Release message), or may notify the UE 100 of the slice IFRI through an MIB. When the notification is performed through the MIB, the slice IFRI may be stored in a field different from that of the conventional IFRI (hereinafter, a “non-slice IFRI”).

The network 50 (gNB 200) may transmit the slice IFRI in association with the slice identifier. For example, the network 50 (gNB 200) may notify the UE 100 and configure the UE 100 so that the slice #1 is “not allowed” and the slice #2 is “allowed”. Alternatively, the slice IFRI may be applied for all slices (i.e. collectively “allowed/not allowed”).

The UE 100 receives the slice IFRI and performs the slice-specific cell reselection procedure based on the slice IFRI. When the network 50 notifies the UE 100 of the slice IFRI (“allowed”), the UE 100 may ignore the non-slice IFRI in the slice-specific cell reselection procedure. On the other hand, when the network 50 does not notify the UE 100 of the slice IFRI, the UE 100 may select another cell within the same frequency in accordance with the non-slice IFRI also in the slice-specific cell reselection procedure.

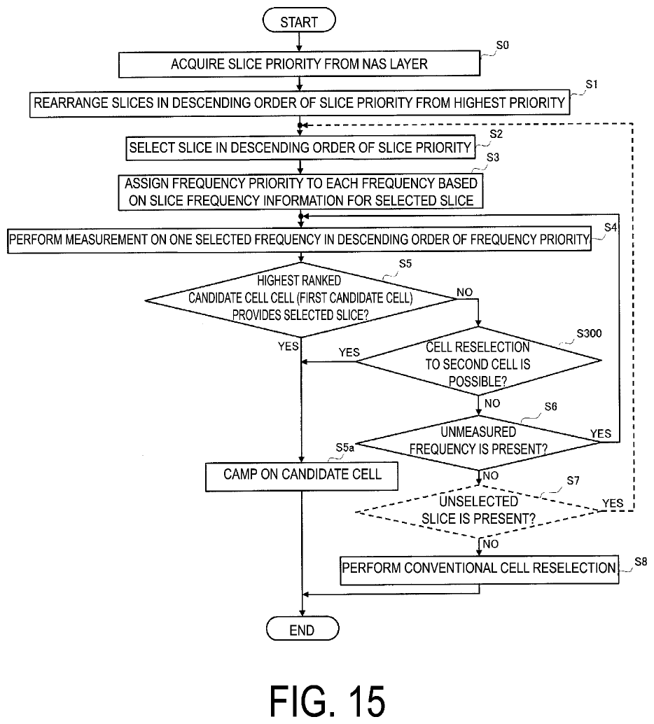

FIG. 15 is a flowchart illustrating a flow of the slice-specific cell reselection procedure according to the third embodiment. Here, differences from FIG. 11 are described.

In step S5, assume that the UE 100 determines that the highest ranked cell (the first candidate cell) does not provide the selected network slice selected in step S2 (step S5: NO).

In step S300, the UE 100 confirms whether the slice IFRI allows cell reselection of the second candidate cell within the same frequency for the selected network slice selected in step S2. When allowed, the UE 100 determines whether the second candidate cell within the same frequency as the first candidate cell provides the selected network slice. Here, the UE 100 performs the determination in the order of the candidate cell ranked the second highest, the candidate cell ranked the third highest, and the like. When determining that the second candidate cell provides the selected network slice, the UE 100 reselects and camps on the second candidate cell (step S5a).

On the other hand, when the slice IFRI does not allow cell reselection of the second candidate cell within the same frequencies (“not allowed”), or when all the second candidate cells do not provide the selected network slice in step S300 and/or all the second candidate cells do not satisfy the minimum quality standard in step S300, the UE 100 performs step S6 and subsequent steps.

### First Variation of Third Embodiment

In the third embodiment described above, when reselection of a cell with a lower rank is allowed without restriction for reselecting the candidate cell ranked the second highest or lower (i.e., the second candidate cell), a problem of interference or the like becomes significant. Therefore, in the present Variation, a certain restriction is put on reselecting the candidate cell ranked the second highest or lower.

In the present Variation, the UE 100, when reselecting the second candidate cell, may reselect the second candidate cell from among a predetermined number of candidate cells counted from the first candidate cell in descending order of radio quality measured in step S4. The configuration information indicating the predetermined number (that is, a rank order limit value) may be configured for the UE 100 from the network 50.

In the present Variation, the UE 100 may camp on the second candidate cell until a predetermined amount of time elapses after reselecting the second candidate cell. The configuration information indicating the predetermined amount of time (that is, a time limit value) may be configured for the UE 100 from the network 50.

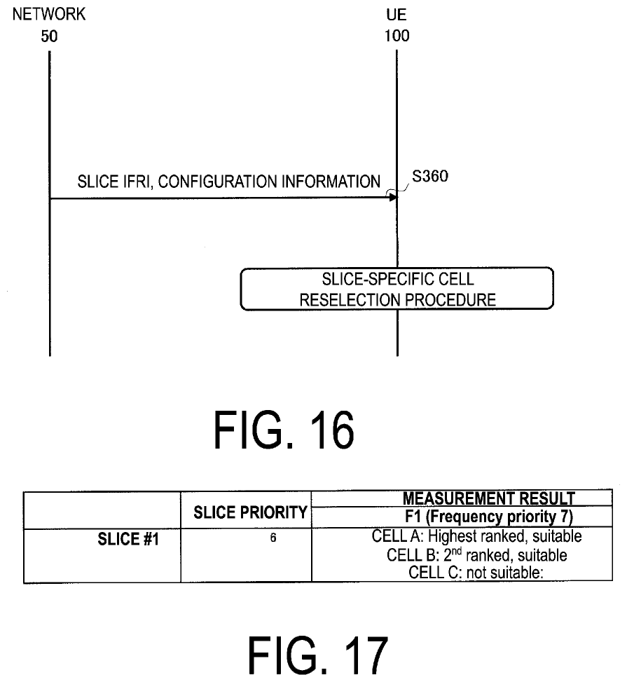

FIG. 16 is a diagram for illustrating the configuration information according to the present Variation.

In step S360, the network 50 (for example, the gNB 200) transmits, to the UE 100, the configuration information related to reselection of the next cell (the second or subsequent highest ranked cell) within the same frequency. The network 50 (for example, the gNB 200) may transmit the configuration information to the UE 100 in the same message as the slice IFRI or may transmit the configuration information to the UE 100 in a message different from the slice IFRI. Alternatively, the configuration information may be a fixed value defined in a technical specification.

The configuration information may include the rank order limit value. The rank order limit value may have content meaning that the same frequency is allowed for up to the second highest ranked cell, for example. The configuration information may include the time limit value. The time limit value may have content meaning the next cell withing the same frequency is allowed to be camped on within one minute, for example.

The UE 100 receives the configuration information and performs the slice-specific cell reselection procedure based on the configuration information.

Now, operations according to the present Variation are described with reference to a concrete example. As illustrated in FIG. 15, in step A4, the UE 100 performs the measurement processing. Assume that this measurement results in a measurement result illustrated in FIG. 17. To be more specific, assume that the slice #1 having the slice priority “6” is the selected network slice and the cells A to C are detected in the frequency F1 having the frequency priority “7”. The cell A is the highest ranked cell and is the candidate cell satisfying the minimum quality standard (suitable). The cell B is the second highest ranked (2^{nd} ranked) cell and is the candidate cell satisfying the minimum quality standard (suitable). The cell C is the cell no satisfying the minimum quality criteria (not suitable).

In such a case, when the highest ranked cell (cell A) does not provide the selected network slice in step S5, the UE 100 attempts to reselect the next candidate cell (cell B) within the same frequency. Here, when the next candidate cell is selected, the configuration information is conformed.

The UE 100 may be allowed to reselect up to the second ranked cell for the operation to reselect the candidate cell within the same frequency, for example, conforming to the rank order limit.

The UE 100 may be allowed to operate only for within one minute for the operation to reselecting the candidate cell within the same frequency (for example, a time period to camp on and remain in the cell), confirming to the time limit. In this case, the UE 100 starts a timer when reselecting the next cell, and performs the slice-specific cell reselection procedure again when the timer expires.

### Second Variation of Third Embodiment

In the present Variation, when the first candidate cell (i.e., the highest ranked cell) does not provide the selected network slice in each of a plurality of selected frequencies selected in accordance with the frequency priorities, the UE 100 reselects the second candidate cell (i.e., the second or subsequent highest ranked cell).

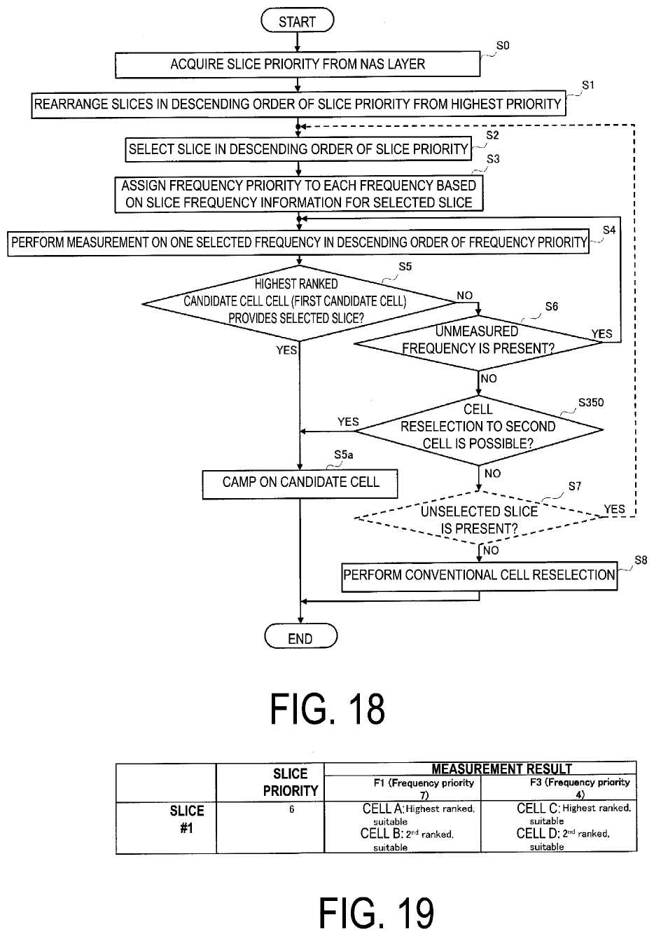

FIG. 18 is a flowchart illustrating a flow of the slice-specific cell reselection procedure according to the present Variation. Here, differences from FIG. 11 are described.

When “NO” in step S6, the UE 100 confirms, in step S350, whether the slice IFRI allows cell reselection of the second candidate cell within the same frequency for the selected network slice selected in step S2. When allowed, the UE 100 determines whether the second candidate cell provides the selected network slice in descending order of frequency priority. When determining that the second candidate cell provides the selected network slice, the UE 100 reselects and camps on the second candidate cell (step S5a).

Operations according to the present Variation are described with reference to a concrete example. As illustrated in FIG. 19, when “NO” in step S6, assumed that the processing for the frequencies F1 and F3 is completed. Here, assume that the highest ranked cells (i.e., the cells A and C) in the respective selected frequencies (the frequencies F1 and F3) for the selected network slice are not selected (camped on). In this case, the UE 100 attempts to camp on the second highest ranked cell (the cell B) in the frequency F1 having the highest frequency priority. When the cell cannot be selected (cannot be camped on), the UE 100 attempts to camp on the second highest ranked cell (the cell D) in the frequency F3 having the second highest frequency priority.

### Fourth Embodiment

A fourth embodiment is described focusing on differences from the first to third embodiments concerning the slice-specific cell reselection procedure.

In the basic flow of the slice-specific cell reselection procedure described above, the UE 100 performs conventional cell reselection in step S8 when the candidate cells within all selected frequencies for the selected network slice do not provide the selected network slice. However, these candidate cells when temporarily not providing the selected network slice, may provide the selected network slice at the time when or after the conventional cell reselection is performed in step S8. Therefore, in the fourth embodiment, the UE 100 preferentially reselects the frequencies and/or candidate cells determined not to provide the selected network slice in step S8.

In the fourth embodiment, the UE 100 that receives, from the network 50, the slice frequency information indicating the correspondence relationship between the network slice, the frequencies, and the frequency priorities assigns the frequency priorities indicated by the slice frequency information to the corresponding frequencies for the selected network slice (step S3), and determines whether a candidate cell provides the selected network slice, the candidate cell satisfying a predetermined quality standard within the selected frequency selected in accordance with the assigned frequency priorities (step S5). The UE 100 performs the cell reselection processing using only the selected frequency or the candidate cell as the reselection candidate when no cell provides the selected network slice in the selected frequency.

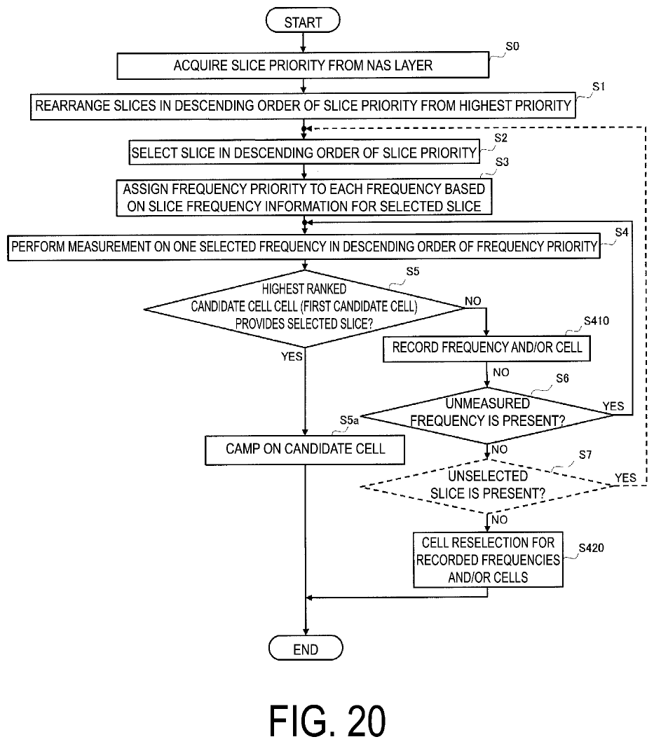

FIG. 20 is a flowchart illustrating a flow of the slice-specific cell reselection procedure according to the fourth embodiment. Here, differences from FIG. 11 are described.

When “NO” in step S5, that is, when the first candidate cell within the selected frequency does not provide the selected network slice, the UE 100 records the selected frequency and/or the first candidate cell in step S410.

For example, in step S410, when the highest ranked cell (or all cells) in a certain frequency does not provide the selected network slice, the UE 100 puts an identifier of the frequency in a first list. In the first list, added is a frequency which is to be reselected but (temporarily) does not provide the selected network slice. Alternatively, when the highest ranked cell (or all cells) in a certain frequency does not provide the selected network slice, the UE 100 puts an identifier of the cell in a second list. In the second list, added is a candidate cell which is to be reselected but (temporarily) does not provide the selected network slice.

After that, in step S420, the UE 100 performs the cell reselection processing based on step S410. For example, in step S420, the UE 100 may raise the priority of the frequency recorded in the first list to perform the cell reselection process. For example, a positive offset may be added to the frequency priority (absolute priority) of the frequency, or the frequency priority of the frequency may be the highest priority. In step S420, the UE 100 may perform the cell reselection processing only on the cell recorded in the second list. Here, the UE 100 may attempt cell reselection in descending order of frequency priority (slice-specific frequency priority) associated with the cell.

### Fifth Embodiment

The embodiments described above describes the example in which the UE 100 grasps the network slice provided or not provided by each cell based on the cell information provided from the network 50.

In the fifth embodiment, the serving cell (gNB 200) may provide neighboring cell information indicating a correspondence relationship between a neighboring cell and a network slice provided by the neighboring cell to the UE 100 through broadcasting. For example, the serving cell (gNB 200) broadcasts a system information block (SIB) including the neighboring cell information. Such an SIB may be another SI (OSI: Other SI) different from minimum system information (Minimum SI) which is always broadcast by each cell. Hereinafter, such OSI including the neighboring cell information is referred to as the “SIBx”.

The neighboring cell information may include a set of a cell identifier of the neighboring cell and an identifier of a network slice provided by the neighboring cell, for each neighboring cell. Alternatively, the neighboring cell information may include a set of a cell identifier of the neighboring cell and an identifier of a network slice not provided by the neighboring cell, for each neighboring cell.

Here, when the neighboring cell information is an optional information element, the serving cell (gNB 200) does not always provide the neighboring cell information to the UE 100. Even when the serving cell (gNB 200) does not provide the neighboring cell information, the UE 100 that does not know that the serving cell does not provide the neighboring cell information may receive and parse SIBx to acquire neighboring cell information. As a result, an unnecessary operation occurs, which is not preferable in terms of power consumption, processing load, and the like of the UE 100.

Therefore, in the fifth embodiment, the serving cell (gNB 200) transmits, to the UE 100, a message indicating whether the serving cell provides the neighboring cell information indicating the correspondence relationship between the neighboring cell and the network slice provided by the neighboring cell. This allows the UE 100 to grasp whether the serving cell provides the neighboring cell information based on the message, avoiding the unnecessary operation as described above from occurring.

The message may be a message constituting the Minimum SI, i.e. a system information block type 1 (SIB1) or a master information block (MIB). For example, the serving cell (gNB 200) may provide a flag (1-bit information) indicating whether to provide the neighboring cell information to the UE 100 in the SIB1 or the MIB. The flag information may be set to “1” when the neighboring cell information is provided, and may be set to “0” when the neighboring cell information is not provided.

Alternatively, the message may be an RRC Release message. For example, when the serving cell (gNB 200) causes the UE 100 to transition from the RRC connected state to the RRC idle state or the RRC inactive state, the serving cell may transmit an RRC Release message including the flag (1-bit information) indicating whether to provide the neighboring cell information to the UE 100.

Alternatively, the message may be a non-access stratum (NAS) message. For example, the serving cell (gNB 200) may transmit a NAS message provided from the AMF to the UE 100, and the NAS message may include the flag (1-bit information) indicating whether to provide the neighboring cell information. The NAS of the UE 100 may notify the AS of the UE 100 of the flag information.

The UE 100 receiving the message from the serving cell determines whether the serving cell provides the neighboring cell information based on the flag information. Then, the UE 100, in response to determining that the serving cell provides the neighboring cell information, receives the SIBx from the serving cell and acquires the neighboring cell information in the SIBx. The UE 100 uses the acquired neighboring cell information for the determination in step S5 described above. For example, based on the acquired neighboring cell information, the UE 100 determines whether the highest ranked cell (neighboring cell) measured in the selected frequency provides the selected network slice.

Note that when determining that the serving cell does not provide the neighboring cell information, the UE 100 may determine, based on the cell information received from the highest ranked cell (neighboring cell) measured in the selected frequency, whether the cell provides the selected network slice in step S5 described above.

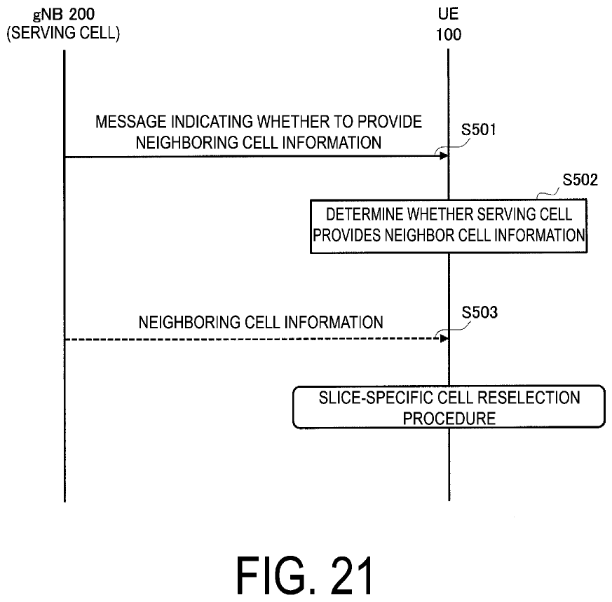

FIG. 21 is a diagram illustrating operation according to the fifth embodiment. As a premise of this operation, the gNB 200 may acquire information (slice information) of a network slice provided or not provided by each neighboring cell through signaling between gNB and gNB, between CU and DU, between DU and DU, and/or between OAM and gNB.

For example, the gNB 200 (CU) may acquire the slice information from the neighboring gNB (CU) managing the neighboring cell by way of an Xn message. The gNB 200 (CU) may acquire information on the slice of the cell managed by the DU of the gNB 200 by way of an F1 message. The gNB 200 (CU) may configure the DU connected to the gNB 200 with whether its own cell (a cell managed by the DU) provides the neighboring cell information described below by way of an F1 message.

In step S501, the gNB 200 (serving cell) transmits, to the UE 100, a message indicating whether the cell of the gNB 200 (serving cell) provides the neighboring cell information indicating a correspondence relationship between a neighboring cell and a network slice provided by the neighboring cell. The UE 100 receives the message.

In step S502, the UE 100 determines whether the serving cell provides the neighboring cell information based on the message received in step S501. The UE 100 may determine whether the gNB 200 (serving cell) broadcasts the SIBx based on SI scheduling information in the SIB1 broadcast by the gNB 200 (serving cell). When the SIBx is an on-demand type SIB transmitted in response to a request from the UE 100, even the gNB 200 (serving cell) providing the neighboring cell information may stop broadcasting the SIBx (not broadcasted). Since the SI scheduling information in the SIB1 includes an information element indicating whether the SIBx is broadcast (not broadcasted) or not broadcast (not broadcasted), the UE 100 may determine whether the gNB 200 (serving cell) broadcasts the SIBx based on the information element.

When determining that the serving cell provides the neighboring cell information, the UE 100 receives the SIBx (OSI) from the serving cell in step S503 to acquire the neighboring cell information and uses the neighboring cell information for the slice-specific cell reselection procedure (in particular for the determination in step S5). Here, when the 1-bit flag information indicates that the serving cell provides the neighboring cell information and the SI scheduling information in the SIB1 indicates that the SIBx is broadcast, the UE 100 may receive the SIBx. In contrast, when the 1-bit flag information indicates that the serving cell provides the neighboring cell information but the SI scheduling information in the SIB1 indicates that the SIBx is not broadcast, the UE 100 may request the serving cell to transmit the SIBx and then receive the SIBx from the serving cell. On the other hand, when determining that the serving cell does not provide the neighboring cell information, the UE 100 may not receive or confirm the SIBx (OSI) from the serving cell.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiment and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of an IAB node. The user equipment may be a Mobile Termination (MT) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing the processes to be performed by the UE 100 or the gNB 200 may be integrated, and at least part of the UE 100 or the gNB 200 may be configured as a semiconductor integrated circuit (a chipset or an SoC).

Embodiments have been described above in detail with reference to the drawings, but specific configurations are not limited to those described above, and various design variation can be made without departing from the gist of the present disclosure.

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

### Supplementary Note

### 1. Introduction

Based on the discussion in RAN2 #115e, the following procedure for the slice-specific cell reselection was agreed.

### Agreements:

### 2. The Following is Taken as the Baseline for Solution Option 4.

The “slice information” (for a single slice or slice group) agreed to be provided to the UE in the last RAN2 using both broadcast and dedicated signaling are provided for the serving as well as neighboring frequencies. The following procedure is used for slice based cell (re)selection in the AS.
Step 0: The NAS layer of the UE provides the slice information to the AS layer of the UE, including the slice priorities.
Step 1: The AS sorts slices in priority order starting with highest priority slice.
Step 2: Select slices in priority order starting with the highest priority slice.
Step 3: For the selected slice, assign the priority to the frequencies received from network.
Step 4: Starting with the highest priority frequency, perform the measurements (same as legacy).
Step 5: When the highest ranked cell is suitable and supports the selected slice in step 2, camp on the cell and ends this sequence of operation. How the UE determines whether the highest ranked cell supports the selected slice needs further study.
Step 6: when there are remaining frequencies, go back to step 4.
Step 7: When the end of the slice list has not been reached, go back to step 2 (further study is required).
Step 8: Perform legacy cell reselection.
1: Solution Option 4 is selected for further study, i.e., resolve the study required matters, send any required LSs and consequently start to draft specification CRs.

In this supplementary note, two further study required matters, step 5 and step 7, are described.
2. Consideration

### 2.1. Further Study Required Matters of Step 5

RAN2 leaves further study required matters of step 5 as follows.
Step 5: When the highest ranked cell is suitable and supports the selected slice in step 2, camp on the cell and ends this sequence of operation.

RAN2 #113bis-e agreed to be consistent with SA2 assumption (homogeneous deployment in TA) as follows.

Agreements (RAN2 #113-bis-e)

1: RAN2 is consistent with SA2 assumption that the slice support within TA is homogeneous in Rel-17 (i.e., all cells within TA support the same slice availability). When SA2 has determined to support heterogeneous deployment, RAN2 may review this.

Homogeneous deployment means that the allowed slices are always available in all cells within TA. On the other hand, TR38.832 identifies a number of problems with resource shortages. For example, “Problem 4: when the serving cell cannot support the requested slice, the serving cell may have to perform a handover to a cell supporting the requested slice or release an RRC connection”. Therefore, the slices are temporarily unavailable in the cell due to the high load and are applied to homogeneous deployment.
Observation 1: Even assuming homogeneous deployment, slices may not be available in time within a cell.

In light of observation 1, the UE in idle/inactive needs to know whether the highest ranked cell supports the selected slice in the slice-specific cell reselection procedure, i.e. the restudy required matters of step 5. In the research phase, it is captured as a conclusion that the UE may be provided with the supported slice information of the adjacent cell from the current cell.

For slice-based cell reselection, the following solution is recommended as an exemplary work.

To support cell reselection, RAN may broadcast the supported slice information of the current cell and neighboring cells and the cell reselection priority per slice in the SI message. RAN may include the slice information (information same as and/or similar to the agreed slice information of the SI message) in the RRC Release message.

When the supported slice information of the adjacent cell is provided, the UE does not need to acquire the system information of the adjacent cell during the slice-specific cell reselection procedure in order to determine whether the highest ranked cell supports the selected slice. Therefore, it is beneficial in terms of power saving of the UE and quick completion of cell reselection.

Observation 2: When the current cell broadcasts the supported slice information of the adjacent cell, the UE can use it to determine whether the highest ranked cell supports the selected slice without acquiring the system information of the adjacent cell.

Therefore, as with the conclusion of the above study, the supported slice information of the neighboring cell should be broadcast as an option.
Proposal 1: RAN2 should agree that, in addition to the agreed slice information (i.e., slice-to-frequency priority mapping), the current cell broadcasts the supported slice information of the neighboring cells.
Proposal 2: RAN2 should agree that the UE determines whether the highest ranked cell supports the selected slice according to the supported slice information as in Proposal 1.

When proposal 1 is accepted, the information is to be considered as the PCI (Physical Cell ID) for each supported slice(s). On the other hand, as in observation 1, in consideration of homogeneous deployment, the cell may not be able to temporarily support the slice(s). Therefore, it is more efficient to broadcast the PCI per unsupported slice(s).
Proposal 3: RAN2 should agree that the cell ID per unsupported slice can be provided to the UE via SIB or RRC Release.

### 2.2. Additional 1-Bit Information in SIB1

When proposal 3 is agreed upon, the cell ID(s) not supporting the slices are provided to the UE from the current cell along with the mapping between slices and frequency priorities. As intended in TR38.832, the adjacent cell information is provided as an option and is therefore not always broadcast. The neighboring cell information may not follow the latest state, for example, when the non-corresponding slice of the neighboring cell is changed). In these cases, the UE may not be able to accurately determine whether the highest ranked cell supports the selected slice in step 5, for example, the intended slice may not actually be supported by the highest ranked cell. To avoid such a situation, the UE may need to always acquire the SIB to check the current state of the highest ranked cell in step 5. However, the acquisition of the SIB takes a long time and consumes the battery of the UE, which is not beneficial. In addition, since acquisition of information from the SIB takes time, it is beneficial to use the SIB1 to notify whether a cell is broadcasting the adjacent cell information.
Observation 3: The corresponding slice information of the neighboring cell in proposal 3 is not always broadcast nor always up-to-date.
Proposal 4: RAN2 should discuss whether to introduce the 1-bit information indicating whether this cell is currently broadcasting the neighboring cell information into SIB1.

In this case, it is beneficial to introduce using the SIB1 to broadcast another 1-bit information that tells the UE whether there is any restriction on at least one slice currently (for example, whether the cell has an unsupported slice). The UE may know in step 5 whether the highest ranked cell has any restrictions on slice support. Thus, the UE does not always need to acquire the SIB, but only needs to receive the SIB while the cell has unsupported slices. Therefore, RAN2 should discuss the additional 1-bit information of SIB1.
Proposal 5: RAN2 should discuss whether to introduce 1-bit information into SIB1. This information indicates whether this cell currently restricts the use of slices of the cell, for example, that this cell has at least one unsupported slice.

### 2.3. Further Study Required Matters in Step 7

RAN2 leaves further study required matters in step 7 as follows.
Step 7: Further study required matters: When the end of the slice list has not been reached, go back to step 2.

As with observation 1, it should be taken into account that the highest ranked cell may not support the slice selected in step 5. In this case, the UE aims to reselect the cell in a frequency having the next highest priority when more frequencies are left, as in step 6. When the UE cannot reselect any cell for the selected slice, go to step 7. when step 7 is performed, the UE may select the next highest priority slice for slice-specific cell reselection.

Considering that the UE can access multiple slices simultaneously, the number of intended slices provided by the NAS may be one or more. Also, as a result of the legacy cell reselection procedure, it is preferable for the UE to reselect a cell that supports the intended slice even though the priority of the slice is not the highest rank, as compared to a cell that may not support the intended slice. In this sense, it is a simple matter that the UE is allowed to select a slice having a priority that is not the highest rank.
Proposal 6: RAN2 should agree that the UE is allowed to select a slice not having the highest priority. Therefore, matters requiring further study are removed from step 7.

1. A cell reselection method performed by a user equipment in a mobile communication system, the cell reselection method comprising:
receiving, from a network, slice frequency information indicating a plurality of frequencies and a network slice group supported by each of the plurality of frequencies; and
when a predetermined frequency not supporting a predetermined network slice group notified by a NAS layer of the user equipment, is present in the slice frequency information, performing control in which a cell belonging to the predetermined frequency is less likely to be selected as a serving cell than a cell belonging to a frequency supporting the predetermined network slice group.

2. The cell reselection method according to claim 1, further comprising:
allocating priorities to each of the plurality of frequencies based on the predetermined network slice group; and
reselecting a candidate cell satisfying a predetermined quality standard based on the priorities,
wherein the reselecting comprises:
specifying a first candidate cell having a highest radio quality; and
when the first candidate cell does not provide the predetermined network slice, respecifying the candidate cell in a frequency same as a frequency which the first candidate cell belongs,
wherein a limitation related to time is provided to the respecifying.

3. A user equipment configured to perform a cell reselection in a mobile communication system, the user equipment comprising:
a circuitry configured to perform:
processing of receiving, from a network, slice frequency information indicating a plurality of frequencies and a network slice group supported by each of the plurality of frequencies; and
when a predetermined frequency not supporting a predetermined network slice group notified by a NAS layer of the user equipment, is present in the slice frequency information, processing of performing control in which a cell belonging to the predetermined frequency is less likely to be selected as a serving cell than a cell belonging to a frequency supporting the predetermined network slice group.

4. A chipset for controlling a user equipment configured to perform a cell reselection in a mobile communication system, the chipset configured to execute processing of:
receiving, from a network, slice frequency information indicating a plurality of frequencies and a network slice group supported by each of the plurality of frequencies; and
when a predetermined frequency not supporting a predetermined network slice group notified by a NAS layer of the user equipment, is present in the slice frequency information, performing control in which a cell belonging to the predetermined frequency is less likely to be selected as a serving cell than a cell belonging to a frequency supporting the predetermined network slice group.

5. A non-transitory computer-readable medium comprising, stored thereupon, computer program instructions for execution by a user equipment configured to perform a cell reselection in a mobile communication system, the program instructions being configured to cause the user equipment to execute processing of:
receiving, from a network, slice frequency information indicating a plurality of frequencies and a network slice group supported by each of the plurality of frequencies; and
when a predetermined frequency not supporting a predetermined network slice group notified by a NAS layer of the user equipment, is present in the slice frequency information, performing control in which a cell belonging to the predetermined frequency is less likely to be selected as a serving cell than a cell belonging to a frequency supporting the predetermined network slice group.

6. A mobile communication system comprising:
a user equipment configured to perform a cell reselection, wherein
the user equipment is configured to:
receive, from a network, slice frequency information indicating a plurality of frequencies and a network slice group supported by each of the plurality of frequencies; and
when a predetermined frequency not supporting a predetermined network slice group notified by a NAS layer of the user equipment, is present in the slice frequency information, perform control in which a cell belonging to the predetermined frequency is less likely to be selected as a serving cell than a cell belonging to a frequency supporting the predetermined network slice group.
